(19) United States
(12) Patent Application Publication
(10) Pub. No.: US 2025/0040646 A1
(43) Pub. Date: Feb. 6, 2025

(54) Transportable Case

(71) Applicants: PAUA TRADING LIMITED, Sussex (GB); Shenzhen Tingshikang Technology Limited, Shenzhen, Guangdong (CN)

(72) Inventors: Peter BLADD-SYMMS, Sussex (GB); Qiang GUO, Shenzhen, Guangdong (CN)

(21) Appl. No.: 18/709,139

(22) PCT Filed: Sep. 19, 2022
(86) PCT No.: PCT/CN2022/119545

§ 371 Date: May 10, 2024

(30) Foreign Application Priority Data
Nov. 10, 2021 (WO) PCT/CN2021/129732

(51) Int. Cl. A42B 3/12; B32B 5/02; B32B 5/18; B32B 5/24; B32B 5/26; B32B 5/32; B32B 37/06; B32B 37/10; B32B 37/18; B65D 25/14; B65D 65/40; B65D 65/42; B65D 81/02

(52) U.S. Cl. CPC A42B 3/125; B32B 5/024; B32B 5/18; B32B 5/245; B32B 5/262; B32B 5/32; B32B 37/06; B32B 37/10; B32B 37/18; B65D 25/14; B65D 65/40; B65D 65/42; B65D 81/022; B32B 2255/02; B32B 2262/0253; B32B 2266/025; B32B 2266/104; B32B 2305/022; B32B 2305/188; B32B 2307/72; B32B 2307/7376; B32B 2309/02; B32B 2309/12; B32B 2323/04; B32B 2323/10; B32B 2437/04; B32B 2439/40

(57) ABSTRACT

A transportable case for containing an item, the transportable case having at least one wall comprising a first layer, formed of microcellular foam and a second layer, formed of self-reinforced polymer woven composite, covering at least part of the first layer. The first layer and the second layer are bonded together and moulded into a shape defining a cavity for receiving at least part of the item, the first layer being an inner layer that is closer to the cavity than the second layer.

### FIELD OF INVENTION

A transportable case for transportation and storage of an item. The case comprises an inner layer of microcellular foam and an outer layer of self-reinforced polymer woven composite. Also described is a method of manufacture for the transportable case. Finally, a helmet having a layered structure is described.

### BACKGROUND TO THE INVENTION

Cases, covers and boxes of various types are commonplace for use in the transportation and storage of items. Cases may be used for containment, or for protection. Various types of case, cover or box are available. One option is cardboard boxes, with internal foam or bubble wrap layers. Such cases may be low cost, but tend to be single-use and so wasteful. Plastic or metal boxes may be used, optionally with inner layers of foam. Such cases are typically robust, and may offer better protection to an item inside against impacts. However, they can also be heavy, which increases transportation costs and reduces energy efficiency of transportation.

Thus, there is required an improved transportable case for transportation and storage of an item.

### SUMMARY OF THE INVENTION

There is described a case, box or cover having walls with an inner layer of microcellular foam (such as microcellular polypropylene) and an outer layer of self-reinforced polymer woven composite (such as self-reinforced polypropylene woven composite). Such a case is particularly hardwearing yet lightweight, and can be formed at lower temperatures and pressures than cases using typical layered self-reinforced polymer using well established moulding techniques typical in the processing of ethylene-vinyl acetate foam. The cases are resilient and have a rigid or semi-rigid moulded shape.

In a first aspect according to the invention there is described a transportable case for containing an item, the transportable case having at least a portion of one or more wall comprising:
a first layer, formed of microcellular foam; and
a second layer, formed of self-reinforced polymer woven composite, covering at least part of the first layer;
wherein the first layer and the second layer are bonded together and arranged in the one or more wall so that the first layer is an inner layer that is closer to a cavity defined within the transportable case than the second layer, wherein the cavity is for receiving at least part of the item. In certain examples, the layered structure may make up part of a wall, such as a portion or panel within a base of the transportable case. In other cases, the layered structure may make up a whole of some walls of a case, together with other types of material or construction in other walls of the same case. Alternatively, all walls of the case may be formed using the layered structure.

In some examples, the first layer and the second layer may be bonded together and moulded into a shape defining a cavity for receiving at least part of the item, the first layer being an inner layer that is closer to the cavity than the second layer.

Microcellular foam is a specific type of polymer foam comprising a large number of very small bubbles uniformly distributed therethrough. The small bubbles are created by dissolving a gas under high pressure within liquid or molten polymer material, and then allowing the polymer to cool whilst the gas bubbles are retained. The resulting closed cell foam is a lightweight but relatively rigid material. Preferably, the microcellular foam is a microcellular polypropylene single polymer composite, a microcellular polyethylene single polymer composite, or a microcellular polyethylene/polypropylene blend.

The self-reinforced polymer woven composite is a specific type of self-reinforced polymer. Whereas typical self-reinforced polymer sheets are formed from heat and compression of layered tapes of aligned, stretched polymer fibres in the same polymer matrix, the self-reinforced polymer woven composite instead comprises a fabric or sheet formed from woven or interlocking threads or yarns of stretched polymer fibres. Before weaving, the threads or yarns may themselves be formed of multiple strands twisted or braided together. In some cases, the woven or interlocking threads or yarns can be compressed under heat and pressure to form the final self-reinforced polymer woven composite material, in which the interlocking polymer fibres are surrounded by a polymer matrix. Compared to typical self-reinforced polymer sheets formed from layered tapes, the self-reinforced polymer woven composite does not suffer from delamination, and may provide superior resistance to tearing or penetration even when used in thin layers. Preferably, the self-reinforced polymer woven composite is a self-reinforced polypropylene woven composite or a self-reinforced polyethylene woven composite.

Preferably, the polymer of the first layer formed of microcellular foam is of the same type of polymer as that of the second layer formed of self-reinforced polymer woven composite. This enables mixing and bonding of the first and second layer at their interface. For instance, the first layer may be a microcellular polypropylene single polymer composite and the second layer may be a self-reinforced polypropylene woven composite.

It will be understood that the polymer described (being part of a microcellular polymer foam, and/or part of the self-reinforced polymer woven composite) may be any type of polyolefin. Preferably, layers within the transportable case, including the microcellular polymer foam and/or the self-reinforced polymer woven composite, will be formed from the same type of polymer. This improves adhesion by thermo-bonding, as chemical bonds can more easily be formed between like polymer types, Moreover, end-of-life recycling of the case is more straightforward if only a single type of polymer is used.

Preferably, when forming the walls of a case, the first layer and second layer are bonded at the majority (i.e. more than 50%, and more preferably more than 75%) of their interfacing surfaces. The bonding together and moulding into shape of the first and second layer occurs by heating and compressing together the first and second layer, for instance between the jaws of a mould, and allowing the layers to cool whilst held in the defined shape (for example, whilst in the jaws of the mould). After the bonding and moulding process, the layers are set into the shape defined by the mould.

Optionally, the case may further comprise a lining layer, on an inner surface of the first layer, such that the first layer is between the lining layer and the second layer. In other words, the lining layer lines the cavity defined within the case for receiving an item. The lining layer may be a soft nylon, or felt layer. The lining layer may comprise a spray on velour layer or flock layer. The lining layer may be an insulation layer, or heat reflective layer. The lining layer is preferably of the same polymer or a compatible polymer as the first layer of microcellular foam, in order that the lining layer can be bonded directly to the first layer.

The lining layer may be formed of a polymer-based fabric. Any type of polymer-based fabric may be used. The polymer fabric may advantageously be of the same type of polymer as the polymer of the self-reinforced polymer woven composite and/or the microcellular foam. This may allow for more straightforward end-of-life recycling for the case, because separation of the different components may not be required. Use of the same type of polymer may also allow for easier thermo-bonding of the different layers. The lining layer may be one of a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer. A brushed polypropylene or polyethylene foam may be used.

Optionally, the case may further comprise a coating layer, on an outer surface of the second layer, such that the second layer is between the coating layer and the first layer. The coating layer may provide an outer layer for the case. The coating layer may be formed of a polymer. Advantageously, the coating layer may be formed of the same type of polymer as the polymer of the self-reinforced polymer woven composite and the microcellular foam. The coating layer may be one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer. A brushed polypropylene or polyethylene foam may be used.

Optionally, the case may further comprise an additional foam layer, on an inner surface of the first layer, such that the first layer is between the additional foam layer and the second layer, or on an outer surface of the second layer, such that the second layer is between the foam layer and the first layer. The additional foam layer may be a removable foam insert housed within the cavity, shaped and contoured to hold and retain a specific item within the case. The additional foam layer may be bonded to the inner surface of the microcellular foam layer. The foam may be memory foam (polyurethane material that is sensitive to pressure and temperature), an expanded polypropylene foam, or an ethylene-vinyl acetate foam, for instance. The additional foam layer may itself comprise a plurality of foam layers, each being of different density (for instance, so as to provide a foam of greater density closer to the first layer (microcellular foam layer), and a lower density closest to an item held within the cavity of the case).

Optionally, the self-reinforced polymer woven composite may include an infra-red disruptive polymer additive, a fire retardant polymer additive, or have fire retardant fibres woven therethrough. This may provide additional beneficial properties to the second layer of the wall of the case.

Preferably, the one or more walls are arranged to form a case having a cavity therein for receiving items. The walls may be bonded at seams, or may be connected by fasteners to form a closable opening.

Preferably, the first layer has a thickness of 1.2 mm to 18 mm, and more preferably a thickness of 3 mm to 9 mm. This represents the thickness of the layer of microcellular foam after moulding has taken place (in other words, once the wall of the case has been formed). However, during the process of bonding and moulding the first and second layer the thickness of the microcellular foam first layer will decrease, and so the initial thickness of the first layer comprising microcellular foam (i.e. before bonding and moulding) may be 10% to 40% greater (on average, around 30% greater) than the stated thickness ranges. Therefore, prior to the bonding and moulding step, the microcellular foam layer may have a thickness of 2 to 20 mm, and more preferably 5 to 10 mm.

Preferably, the first layer has a density of 27.5 to 120 kilograms per cubic metre, or more preferably 27.5 to 72 kilograms per cubic metre, or still more preferably 49.5 to 72 kilograms per cubic metre. This represents the density of the layer of microcellular foam after moulding has taken place (in other words, once the wall of the case has been formed). The density of the microcellular foam increases by around 10% to 20% as a result of bonding and moulding steps which comprise heating and compaction of the layers. Therefore, prior to the bonding and moulding step, the microcellular foam layer may have a density of 25 to 100 kilograms per cubic metre, or more preferably 25 to 60 kilograms per cubic metre, or more preferably 45 to 60 kilograms per cubic metre.

It should be noted that the thickness of the microcellular foam could be increased. For instance, the case may be used as a floatation device (for instance, to keep afloat a case whilst containing an item, or to allow the case to act as a platform whilst using the item, such as required for some cases housing military equipment). For this purpose, the thickness of the layer of microcellular foam may be increased to improve the buoyancy of the case overall. Such a change would require a subsequent adaptation of any tool or press used to form the layered walls of the case (as discussed in detail below). It will be understood that said increased buoyancy could also be achieved by use of a foam insert within the case, thereby increasing the volume enclosed within the case walls.

Preferably, the second layer has a thickness of 0.6 mm to 1.4 mm, and more preferably a thickness of 0.8 to 1.2 mm. Prior to forming the wall having the layered structure (i.e. prior to moulding and bonding), the self-reinforced polymer woven composite is thicker, typically around 6 mm to 8 mm. However, the process of bonding and moulding the layers causes the thickness of the self-reinforced polymer woven composite to reduce.

Preferably, the second layer has a density of 400 to 1200 grams per cubic metre, and more preferably a density of 800 to 1000 grams per cubic metre.

Optionally, ribs, grooves or linear indentations may be applied to the second layer of self-reinforced polymer woven composite, or corrugations may be formed in the layer of self-reinforced polymer woven composite. Optionally, corrugations may be formed in both the first and the second layer during the moulding step. Said ribs, grooves or corrugations act to improve the rigidity of the wall of the case once formed. Said features may also increase the surface area of the interfacing, bonded surfaces between the first and the second layers.

Any of the characteristics of features of the case, as described above, can also apply to the common features in the method of manufacture of the transportable case, as described below.

In a second aspect, there is described a method for manufacture of a transportable case for receiving an item, comprising:
providing a first layer, formed of microcellular foam; and
providing a second layer, formed of self-reinforced polymer woven composite, covering at least part of the first layer;
forming a wall of the transportable case by bonding together the first layer and the second layer and moulding the first and the second layer into a shape defining a cavity for receiving at least part of the item, the first layer being an inner layer that is closer to the cavity than the second layer.

The microcellular foam is a foam as described above, and in certain examples may be a microcellular polypropylene single polymer composite, a microcellular polyethylene single polymer composite, or a microcellular polyethylene/polypropylene blend.

The self-reinforced polymer woven composite is a specific form of self-reinforced polymer, as described above. In certain examples, the self-reinforced polymer woven composite is a self-reinforced polypropylene woven composite or a self-reinforced polyethylene woven composite.

Preferably, the bonding and the moulding step take place simultaneously. For example, preferably, the bonding and the moulding comprises heating and compacting together the first and the second layer. The compacting may comprise compressing the first and the second layer in a press. The press may have one or more heated jaws, wherein the jaws have a specific shape or contour. The layers may be arranged between the jaws, and compressed therebetween. This heats the layers between the jaws, by transfer of heat to the layers from the one or more heated jaws. At least a portion of the layers between the jaws melts the polymer materials to a liquid or malleable form, so that the layers can adopt the shape or contours of the jaws. Moreover, flow of the melted or malleable polymer materials allow a bond between the first and the second layers. The layers can be allowed to cool to a temperature below the melting point of both the microcellular foam and the self-reinforced polymer woven composite, or allowed to cool to room temperature, whilst being held within the jaws. The layers will then set having the shape or contours imposed by the jaws. In some examples, only one jaw is heated, or the jaws are heated to different temperatures, in view of the material layers to which a given jaw is in contact. For instance, the jaw in contact with the self-reinforced polymer woven composite may be heated to a higher temperature than the jaw in contact with the microcellular foam layer.

Optionally, the press is a hydraulic press or vulcanising press that is suitable for moulding of ethylene-vinyl acetate (EVA) foam. A press suitable for EVA foam (“EVA press”) would typically not be used for pressing standard self-reinforced polymer material (formed of consolidated layers of self-reinforced polymer material). Use of an EVA press is only possible within the present invention in view of the use of a self-reinforced polypropylene woven composite within the walls of the case.

To provide further detail, an EVA press will commonly only be able to compress at lower pressures and sustain lower temperatures (with less stable temperatures) than higher quality presses typically used for layered forms of self-reinforced polymer. As a consequence, an EVA press does not impart sufficient heat and pressure to a self-reinforced polymer material formed of a number of consolidated layers, in order to be able to mould the layer and cause it to bond to the microcellular foam layer. However, use of the EVA press is possible when using a self-reinforced polypropylene woven composite, even if it has the same thickness as an equivalent a self-reinforced polymer material formed of a number of consolidated layers. This is because heat is more easily transferred through the interlaced strands within the woven fabric. In fact, after weaving of the strands of self-reinforced polymer fibres (especially before the woven fabric is heated to melt a portion of the fibres and generate a polymer matrix surrounding the fibres) the woven fabric may have small holes or gaps between the weaves (or pics) of the woven material. This allows heat to transfer through the self-reinforced polymer woven composite more readily than through the self-reinforced polymer material formed of a number of consolidated layers, in order to melt the surface of the microcellular foam at the interface with the woven material whilst also forming the polymer matrix surrounding the threads of the a self-reinforced polymer woven composite. Benefits of use of an EVA press include availability (as the instrument is less specialised), lower initial costs (for purchase and customisation of a press), as well as lower running costs (in view of reduced energy consumption as a result of lower temperatures and pressures).

In view of the lower temperatures and pressures required for moulding the combination of self-reinforced polymer woven composite and microcellular foam, moulding may also take place by use of an inflatable bladder to compress the layers against a mould. For instance, a metal moulding having the required shape or contour of the walls of the case may be provided, the layers applied against the metal mould and then an inflatable bladder used to press the layers against the metal mould. In this technique, in some examples heat is only transferred to the layers from the metal mould (and not from the bladder). This may be helpful when using the specific combination of the self-reinforced polymer woven composite with microcellular foam, as heat may be transferred to the self-reinforced polymer woven composite directly but without heating the microcellular foam directly, thereby heating at the interface rather than the whole body of the foam (which can cause damage to the foam structure).

Preferably, heating comprises heating at least a portion of the first and the second layer to a temperature above 100° C. Preferably, heating comprises heating at least a portion of the first and the second layer to a temperature of 100° C. to 200° C., more preferably to a temperature of 130° C. to 170° C., and still more preferably to a temperature of 140° C. to 160° C. At temperatures lower than this, the polymer (particularly the polymer matrix of the self-reinforced polymer woven composite) will not become sufficiently liquid to flow and be moulded and to bond to the microcellular layer. However, at temperatures higher than this, the microcellular foam layer may become too liquid, such that compaction within the jaws of the press causes the gas bubbles inherent in the structure of the microcellular foam to be forced out. Upon cooling from the preferred range of temperatures, the microcellular foam is observed to shrink in volume (typically by around 30%) and increase in density (typically by around 15%). This may be a consequence of loss of some of the cellular structure from the foam. Thus, there is a balance between the temperature required to mould the self-reinforced polymer woven composite without overly distorting the structure of the microcellular foam. The density and the thickness of the self-reinforced polymer woven composite layer must also be selected appropriately such that sufficient heat is imparted to the self-reinforced polymer woven composite without distortion or damage to the microcellular foam layer.

Preferably compacting together the first and second layer comprises applying a pressure of 0.1 to 10 tonne per square inch (around 224 psi to 22400 psi), and more preferably 1 to 10 tonne per square inch (1550) to 15500 tonne per square metre) and more preferably 2 to 4 tonne per square inch (3100 to 6200 tonne per square metre) to at least a portion of the first and second layer. For example, said pressure may be applied by the jaws of a press to a portion of each of the first and second layer arranged between the jaws. Application of excessive pressure can damage or modify the microcellular structure of the foam of the first layer. However, insufficient pressure may prevent moulding of the self-reinforced polymer woven composite layer to the required shape.

Preferably, compressing the first and the second layer in a press and/or compacting together the first and second layer whilst applying temperature and/or pressure takes place for between 30 to 300 seconds, more preferably 30 to 180 seconds, or more preferably 30 to 90 seconds. Applying temperature and/or pressure may takes place for between 60 and 120 seconds. The temperature, pressure, and time for application will be adapted dependent on the thickness and density of the first and second layer. It is noted that the gradient of the heating and cooling (which may be modified by the combination of the applied temperature, pressure, and time of compression within a press) may affect the quality of the resultant layers, including the amount of shrinkage for each layer. Some shrinkage of the self-reinforced polymer woven composite layer may be advantageous to provide improved grip and bonding to the microcellular foam layer.

Preferably, the wall of the transportable cases is a first wall, and the method further comprises forming one or more further walls by repeating the providing, bonding and moulding steps. The method may then further comprise joining the first wall to the one or more further walls by connection at a seam, and/or by connection with a reversible fastener. In other words, a first and at least a second wall can be formed, each having a first layer of microcellular foam and a second layer of self-reinforced polymer woven composite, as described above. The walls of the case are joined, connected or bonded together to form the case, wherein the cavity defined in each wall is enclosed within the case for receiving an item therein.

Preferably, the first layer provided prior to the forming step has a thickness of 2 to 20 mm, and more preferably 5 to 10 mm. It should be noted that in the process of forming the wall (by bonding and moulding), the thickness of first layer is reduced by around 10% to 40%, and on average by around 30%. Therefore, after the forming step, the first layer may be expected to have a thickness of 1.2 to 18 mm, and more preferably 3 to 9 mm.

Preferably, the first layer provided prior to the forming step has a density of 25 to 100 kilograms per cubic metre, more preferably 25 to 60 kilograms per cubic metre, and still more preferably 45 to 60 kilograms per cubic metre. However, in the process of forming the wall (by bonding and moulding), the density of the first layer is increased by around 10% to 20%. Therefore, after the forming step, the first layer may be expected to have a density of 27.5 to 120 kilograms per cubic metre, more preferably 27.5 to 72 kilograms per cubic metre, and still more preferably 49.5 to 72 kilograms per cubic metre.

Preferably, the second layer provided prior to the forming step has a thickness of 5 to 10 mm, and more preferably 6 and 8 mm. However, the thickness of the second layer is dramatically reduced during the forming step, and so after the forming step the second layer may be expected to have a thickness of 0.6 mm to 1.4 mm, and more preferably a thickness of 0.8 to 1.2 mm.

Preferably, the second layer has a density of 400 to 1200 grams per cubic metre, and more preferably a density of 800 to 1000 grams per cubic metre.

Optionally, the method may further comprise providing a lining layer, arranged on an inner surface of the first layer, such that the first layer is between the lining layer and the second layer. The lining layer may be formed from a polymer. Advantageously, the polymer of the lining layer may be the same type of polymer as used within the microcellular foam and the self-reinforced polymer woven composite. Optionally, the lining layer may be one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, or a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer.

Optionally, the method may further comprise providing a coating layer, arranged on an outer surface of the second layer, such that the second layer is between the coating layer and the first layer. The coating may be the outermost layer of the case. The coating layer may be formed from a polymer. Advantageously, the polymer of the coating layer may be the same type of polymer as used within the microcellular foam and the self-reinforced polymer woven composite. The coating layer may be one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, or a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

Optionally, the method may further comprise providing a foam layer, the foam layer arranged on an inner surface of the first layer, such that the first layer is between the foam layer and the second layer, or the foam layer arranged on an outer surface of the second layer, such that the second layer is between the foam layer and the first layer. The foam layer may be a polymer foam, being the same type of polymer as used within the microcellular foam and the self-reinforced polymer woven composite. A surface of the foam layer may be brushed, to change or soften the texture of the foam layer. The foam layer may be an outermost layer of the case.

Optionally, the method may further comprise applying a pattern or print to the outer surface of the second layer by hydro-dipping (also known as water transfer printing, immersion printing, water transfer imaging, or water marbling). In other words, surface decoration may be applied to the outer surface of the self-reinforced polymer woven composite layer. This can provide an aesthetically pleasing appearance for the outside of the case, or may enable a label or trademark to be applied. The pattern may be applied to the outer surface of the case after the walls of the case have been formed or may be applied to a surface of the self-reinforced polymer woven composite prior to forming the layered wall structure for the case.

In another aspect, there is a transportable case for containing an item, the transportable case having at least a portion of one or more wall comprising:
a first layer, formed of microcellular foam; and
a second layer, formed of self-reinforced polymer woven composite, covering at least part of the first layer;
wherein the first layer and the second layer are bonded together and arranged in the one or more wall so that the second layer is an inner layer that is closer to a cavity defined within the transportable case than the first layer, wherein the cavity is for receiving at least part of the item.

In some examples, the first layer and the second layer are bonded together and moulded into a shape defining a cavity for receiving at least part of the item, the second layer being an inner layer that is closer to the cavity than the first layer.

In other words, the transportable case may be formed having the microcellular foam as an outer layer than compared to a self-reinforced polymer woven composite layer. The microcellular foam and the self-reinforced polymer woven composite layer may have any of the same characteristics as described above in relation to other aspects or examples of the transportable case.

Preferably, the microcellular foam is microcellular polypropylene single polymer composite, a microcellular polyethylene single polymer composite, or a microcellular polyethylene/polypropylene blend.

Preferably, the self-reinforced polymer woven composite is a self-reinforced polypropylene woven composite or a self-reinforced polyethylene woven composite.

Preferably, the transportable case further comprises a lining layer on an inner surface of the second layer, such that the second layer is between the lining layer and the first layer. The lining layer may be formed of the same type of polymer as the microcellular foam and/or the self-reinforced polymer woven composite. The lining layer may be one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

Optionally, the transportable case further comprises a coating layer on an outer surface of the first layer, such that the first layer is between the coating layer and the second layer. The coating layer may be formed of the same type of polymer as the microcellular foam and/or the self-reinforced polymer woven composite. The coating layer may be one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

Optionally, the transportable case further comprises a foam layer, wherein the foam layer is on an inner surface of the second layer, such that the second layer is between the foam layer and the first layer, or wherein the foam layer is on an outer surface of the first layer, such that the first layer is between the foam layer and the second layer. The foam layer may be of the same type of polymer as the microcellular foam and/or the self-reinforced polymer woven composite.

Optionally, the first layer may have a thickness of 1.2 mm to 18 mm. The first layer may have a density of 27.5 to 120 kg/m³.

Optionally, the second layer may have a thickness of 0.6 to 1.4 mm. The second layer may have a density of 400 to 1200 g/m³.

In a still further aspect, there is a method for manufacture of a transportable case for receiving an item, comprising:
providing a first layer, formed of microcellular foam; and
providing a second layer, formed of self-reinforced polymer woven composite, covering at least part of the first layer;
forming a wall of the transportable case by bonding together the first layer and the second layer and moulding the first and the second layer into a shape defining a cavity for receiving at least part of the item, the second layer being an inner layer that is closer to the cavity than the first layer.

In a yet further aspect, there is a method for manufacture of a transportable case for receiving an item, comprising:
providing a first layer, formed of microcellular foam; and
providing a second layer, formed of self-reinforced polymer woven composite, covering at least part of the first layer;
forming at least a portion of a wall of the transportable case by bonding together the first layer and the second layer.

Preferably, the bonding and the moulding comprise heating and compacting together the first and the second layer. Optionally, compacting comprises compressing the first and the second layer in a press.

Preferably, the microcellular foam is microcellular polypropylene single polymer composite, a microcellular polyethylene single polymer composite, or a microcellular polyethylene/polypropylene blend

Preferably, the self-reinforced polymer woven composite is a self-reinforced polypropylene woven composite or a self-reinforced polyethylene woven composite.

Optionally, the transportable case may comprise a lining layer, arranged on an inner surface of the second layer, such that the second layer is between the lining layer and the first layer. The lining layer may be formed from the same type of polymer as the microcellular foam and/or the self-reinforced polymer woven composite. The lining layer may be one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

Optionally, the transportable case may comprise providing a coating layer, arranged on an outer surface of the first layer, such that the first layer is between the coating layer and the second layer. The coating layer may be formed from the same type of polymer as the microcellular foam and/or the self-reinforced polymer woven composite. The coating layer may be one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

Optionally, the transportable case may further comprise providing a foam layer, the foam layer arranged on an inner surface of the second layer, such that the second layer is between the foam layer and the first layer, or the foam layer arranged on an outer surface of the first layer, such that the first layer is between the foam layer and the second layer. The foam layer may be of the same type of polymer as the microcellular foam and/or the self-reinforced polymer woven composite.

The bonding of any lining layer, coating layer and/or foam layer may take place simultaneously with the bonding and moulding step of the microcellular foam and/or the self-reinforced polymer woven composite. In other words, the lining layer, coating layer and/or foam layer may take place by thermo-bonding (or thermo-compression).

Optionally, the first layer may be provided prior to the forming step having a thickness of 2 and 20 mm. The first layer may be provided prior to the forming step having a density of 25 to 100 kg/m³.

Optionally, the second layer may be provided prior to the forming step having a thickness of 5 to 10 mm. The second layer may be provided prior to the forming step having a density of 400 to 1200 g/m³.

Optionally, heating may comprise heating at least a portion of the first and second layer to a temperature of 130 to 170°. Compacting together may comprise applying a pressure of 1 to 10 tonne per square inch to at least a portion of the first and second layer.

Optionally, the method may further comprise applying a pattern or print to the outer surface of the second layer by hydro dipping.

In a still further aspect there is a helmet, for protection of a user's head, comprising:
a first layer, formed of microcellular foam; and
a second layer, formed of self-reinforced polymer woven composite, covering at least part of the first layer;
wherein the first layer and the second layer are bonded together and moulded into a shape defining a cavity for receiving at least part of the user's head, the first layer being an inner layer that is closer to the cavity than the second layer.

In other words, the helmet is formed from a layered structure of microcellular foam and self-reinforced polymer woven composite. The layers of the helmet can be bonded and moulded in a single step. This provides some advantages compared to a typical helmet, in which foam pads may be applied to a shell structure, in a separate step, after forming of the shell by moulding and shaping. The presently described helmet (formed of microcellular foam and self-reinforced polymer woven composite) provides better adhesion between the first and second layer than a typical helmet construction having foam inserts applied to a shell. This allows impact energy to transfer more predictably through the helmet. Moreover, upon the application of shearing forces any movement of the first and second layer relative to each other can be reduced. Finally, manufacture may be more efficient, and the helmet can be moulded and shaped in a single step.

The microcellular foam may be microcellular polypropylene single polymer composite, a microcellular polyethylene single polymer composite, or a microcellular polyethylene/polypropylene blend. The characteristics and properties of microcellular foam are described above and are applicable here.

The self-reinforced polymer woven composite may be a self-reinforced polypropylene woven composite or a self-reinforced polyethylene woven composite. The characteristics and properties of self-reinforced polymer woven composite are described above and are applicable here.

The helmet may further comprise one or more structural support, each formed by a compacted region of the bonded together and moulded first and second layer. The one or more structural support acts to provide the required stiffness and strength in order to resist forces (impacts or shearing forces) applied to the outer surface of the helmet. The structural support regions increase the stiffness and rigidity of the helmet. The regions are formed by compacting together areas of the microcellular foam and self-reinforced polymer woven composite layers. Such compacting acts to remove much or all of the air pockets or bubbles from the microcellular foam in the structural supports regions, increasing the density of the microcellular foam (and in some cases the self-reinforced polymer woven composite layers) in these regions.

Each compacted region may have a thickness being 30% or less of the thickest region of the bonded together and moulded first and second layer. The thickness may be 50% or less, 40% or less, 25% or less, 20% or less or 15% or less of the thickest region of the bonded together and moulded first and second layer. The thinner the compacted regions (meaning the lower the percentage) then the higher the density the regions of microcellular foam and self-reinforced polymer woven composite will be. Typically, increasing the density will increase the stiffness of the compacted regions. In an example, each compacted region has a thickness of 1 mm to 3 mm.

The helmet may further comprise a lining layer, on an inner surface of the first layer, such that the first layer is between the lining layer and the second layer. The lining layer may comprise one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer.

The helmet may further comprise a coating layer, on an outer surface of the second layer, such that the second layer is between the coating layer and the first layer. The coating layer may comprise one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer.

The helmet may further comprise a foam layer, on an inner surface of the first layer, such that the first layer is between the foam layer and the second layer, or on an outer surface of the second layer, such that the second layer is between the foam layer and the first layer. The foam layer may be a polymer foam.

The first layer may have a thickness of 3 mm to 25 mm. This may be the thickness at the thickest region of the bonded together and moulded first and second layer. Alternatively, this may be the thickness prior to the step of bonding together and moulding.

The first layer may have a density of 25 to 80 kg/m³. This may be the density at the thickest region of the bonded together and moulded first and second layer. Alternatively, this may be the density prior to the step of bonding together and moulding.

The second layer may have a thickness of 1.5 mm to 15 mm. This may be the thickness at the thickest region of the bonded together and moulded first and second layer. Alternatively, this may be the thickness prior to the step of bonding together and moulding.

The second layer may have a density of 400 to 1200 g/m³. This may be the density at the thickest region of the bonded together and moulded first and second layer. Alternatively, this may be the density prior to the step of bonding together and moulding.

In yet another aspect, there is a method of manufacture for the above described helmet. It will be understood that the method of manufacture described for the transportable box could also be applied to form the helmet. The structural supports in the helmet can be created by regions of a press creating a pattern or contour in the layers, in order to compress to a greater extent than other portions of the press the regions forming the structural support.

Certain illustrative examples are described in the following numbered clauses:

1. A transportable case for containing an item, the transportable case having at least one wall comprising:
a first layer, formed of microcellular foam; and
a second layer, formed of self-reinforced polymer woven composite, covering at least part of the first layer;
wherein the first layer and the second layer are bonded together and moulded into a shape defining a cavity for receiving at least part of the item, the first layer being an inner layer that is closer to the cavity than the second layer.

2. The transportable case of clause 1, wherein the microcellular foam is microcellular polypropylene single polymer composite, a microcellular polyethylene single polymer composite, or a microcellular polyethylene/polypropylene blend.

3. The transportable case of clause 1 or clause 2, wherein the self-reinforced polymer woven composite is a self-reinforced polypropylene woven composite or a self-reinforced polyethylene woven composite.

4. The transportable case of any one of clauses 1 to 3, further comprising a lining layer, on an inner surface of the first layer, such that the first layer is between the lining layer and the second layer.

5. The transportable case of clause 4, wherein the lining layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer.

6. The transportable case of clause 5, further comprising a coating layer, on an outer surface of the second layer, such that the second layer is between the coating layer and the first layer.

7 The transportable case of clause 6, wherein the coating layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer.

8. The transportable case of any one of clauses 1 to 7, further comprising a foam layer, on an inner surface of the first layer, such that the first layer is between the foam layer and the second layer, or on an outer surface of the second layer, such that the second layer is between the foam layer and the first layer.

9. The transportable case of any one of clauses 1 to 8, wherein the first layer has a thickness of 1.2 mm to 18 mm.

10. The transportable case of any one of clauses 1 to 9, wherein the first layer has a density of 27.5 to 120 kg/m³.

11. The transportable case of any one of clauses 1 to 10, wherein the second layer has a thickness of 0.6 to 1.4 mm.

12. The transportable case of any one of clauses 1 to 11, wherein the second layer has a density of 400 to 1200 g/m³.

13. A method for manufacture of a transportable case for receiving an item, comprising:
providing a first layer, formed of microcellular foam; and
providing a second layer, formed of self-reinforced polymer woven composite, covering at least part of the first layer;
forming a wall of the transportable case by bonding together the first layer and the second layer and moulding the first and the second layer into a shape defining a cavity for receiving at least part of the item, the first layer being an inner layer that is closer to the cavity than the second layer.

14. The method of clause 13, wherein the bonding and the moulding comprise heating and compacting together the first and the second layer.

15. The method of clause 13 or clause 14, wherein compacting comprises compressing the first and the second layer in a press.

16. The method of any one of clauses 13 to 15, wherein the microcellular foam is microcellular polypropylene single polymer composite, a microcellular polyethylene single polymer composite, or a microcellular polyethylene/polypropylene blend

17. The method of any one of clauses 13 to 16, wherein the self-reinforced polymer woven composite is a self-reinforced polypropylene woven composite or a self-reinforced polyethylene woven composite.

18. The method of any one of clauses 13 to 17, further comprising providing a lining layer, arranged on an inner surface of the first layer, such that the first layer is between the lining layer and the second layer.

19. The method of clause 18, wherein the lining layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

20. The method of any one of clauses 13 to 19, further comprising providing a coating layer, arranged on an outer surface of the second layer, such that the second layer is between the coating layer and the first layer.

21. The method of clause 20, wherein the coating layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

22. The method of any one of clauses 13 to 21, further comprising providing a foam layer, the foam layer arranged on an inner surface of the first layer, such that the first layer is between the foam layer and the second layer, or the foam layer arranged on an outer surface of the second layer, such that the second layer is between the foam layer and the first layer.

23. The method of any one of clauses 13 to 22, wherein the first layer provided prior to the forming step has a thickness of 2 and 20 mm.

24. The method of any one of clauses 13 to 23, wherein the first layer provided prior to the forming step has a density of 25 to 100 kg/m³.

25. The method of any one of clauses 13 to 24, wherein the second layer provided prior to the forming step has a thickness of 5 to 10 mm.

26. The method of any one of clauses 13 to 25, wherein the second layer provided prior to the forming step has a density of 400 to 1200 g/m³.

27. The method of any one of clauses 13 to 26, wherein heating comprises heating at least a portion of the first and second layer to a temperature of 130 to 170°.

28. The method of any one of clauses 13 to 27, wherein compacting together comprises applying a pressure of 0.1 to 10 tonne per square inch to at least a portion of the first and second layer.

29. The method of any one of clauses 13 to 28, wherein compacting together comprises applying a pressure of 1 to 10 tonne per square inch to at least a portion of the first and second layer.

30. The method of any one of clauses 13 to 29, further comprising applying a pattern or print to the outer surface of the second layer by hydro dipping.

31. A transportable case for containing an item, the transportable case having at least one wall comprising:
a first layer, formed of microcellular foam; and
a second layer, formed of self-reinforced polymer woven composite, covering at least part of the first layer;
wherein the first layer and the second layer are bonded together and moulded into a shape defining a cavity for receiving at least part of the item, the second layer being an inner layer that is closer to the cavity than the first layer.

32. The transportable case of clause 31, wherein the microcellular foam is microcellular polypropylene single polymer composite, a microcellular polyethylene single polymer composite, or a microcellular polyethylene/polypropylene blend.

33. The transportable case of clause 31 or clause 32, wherein the self-reinforced polymer woven composite is a self-reinforced polypropylene woven composite or a self-reinforced polyethylene woven composite.

34. The transportable case of any one of clauses 31 to 33, further comprising a lining layer, on an inner surface of the second layer, such that the second layer is between the lining layer and the first layer.

35. The transportable case of clause 34, wherein the lining layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

36. The transportable case of any one of clauses 31 to 35, further comprising a coating layer, on an outer surface of the first layer, such that the first layer is between the coating layer and the second layer.

37. The transportable case of clause 36, wherein the coating layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

38. The transportable case of any one of clauses 31 to 37, wherein further comprising a foam layer, wherein the foam layer is on an inner surface of the second layer, such that the second layer is between the foam layer and the first layer, or wherein the foam layer is on an outer surface of the first layer, such that the first layer is between the foam layer and the second layer.

39. The transportable case of any one of clauses 31 to 38, wherein the first layer has a thickness of 1.2 mm to 18 mm.

40. The transportable case of any one of clauses 31 to 39, wherein the first layer has a density of 27.5 to 120 kg/m³.

41. The transportable case of any one of clauses 31 to 40, wherein the second layer has a thickness of 0.6 to 1.4 mm.

42. The transportable case of any one of clauses 31 to 41, wherein the second layer has a density of 400 to 1200 g/m³.

43. A method for manufacture of a transportable case for receiving an item, comprising:
providing a first layer, formed of microcellular foam; and
providing a second layer, formed of self-reinforced polymer woven composite, covering at least part of the first layer;
forming a wall of the transportable case by bonding together the first layer and the second layer and moulding the first and the second layer into a shape defining a cavity for receiving at least part of the item, the second layer being an inner layer that is closer to the cavity than the first layer.

44. The method of clause 43, wherein the bonding and the moulding comprise heating and compacting together the first and the second layer.

45. The method of clause 43 or clause 44, wherein compacting comprises compressing the first and the second layer in a press.

46. The method of any one of clauses 43 to 45, wherein the microcellular foam is microcellular polypropylene single polymer composite, a microcellular polyethylene single polymer composite, or a microcellular polyethylene/polypropylene blend

47. The method of any one of clauses 43 to 46, wherein the self-reinforced polymer woven composite is a self-reinforced polypropylene woven composite or a self-reinforced polyethylene woven composite.

48. The method of any one of clauses 43 to 47, further comprising providing a lining layer, arranged on an inner surface of the second layer, such that the second layer is between the lining layer and the first layer.

49. The transportable case of clause 48, wherein the lining layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

50. The transportable case of any one of clauses 43 to 49, further comprising providing a coating layer, arranged on an outer surface of the first layer, such that the first layer is between the coating layer and the second layer.

51. The transportable case of clause 50, wherein the coating layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

52. The transportable case of any one of clauses 43 to 51, further comprising providing a foam layer, the foam layer arranged on an inner surface of the second layer, such that the second layer is between the foam layer and the first layer, or the foam layer arranged on an outer surface of the first layer, such that the first layer is between the foam layer and the second layer.

53. The method of any one of clauses 43 to 52, wherein the first layer provided prior to the forming step has a thickness of 2 and 20 mm.

54. The method of any one of clauses 43 to 53, wherein the first layer provided prior to the forming step has a density of 25 to 100 kg/m³.

55. The method of any one of clauses 43 to 54, wherein the second layer provided prior to the forming step has a thickness of 5 to 10 mm.

56. The method of any one of clauses 43 to 55, wherein the second layer provided prior to the forming step has a density of 400 to 1200 g/m³.

57. The method of any one of clauses 43 to 56, wherein heating comprises heating at least a portion of the first and second layer to a temperature of 130 to 170°.

58. The method of any one of clauses 43 to 57, wherein compacting together comprises applying a pressure of 1 to 10 tonne per square inch to at least a portion of the first and second layer.

59. The method of any one of clauses 43 to 58, further comprising applying a pattern or print to the outer surface of the second layer by hydro dipping.

### BRIEF DESCRIPTION OF THE FIGURES

The invention can be put into practice in a number of ways, and preferred embodiments will now be described by way of example only and with reference to the accompanying drawings, in which:

FIG. 1 shows the steps for manufacture of a wall of a case;

FIG. 2 shows a plan view and a cross-sectional view of the case having the walls as described:

FIG. 3 shows a cross-sectional view of the case having an additional lining laver:

FIG. 4 shows a cross-sectional view of the case having an additional foam layer:

FIG. 5 shows a cross-sectional view of another example of a case having a lining layer and a coating layer; and

FIG. 6 shows a helmet formed having a layered structure. FIG. 6 (a) shows a side view of the helmet, and FIG. 6 (b) shows a cross-sectional view of the same helmet.

In the figures, like parts are denoted by like reference numerals. The figures are not drawn to scale.

### DETAILED DESCRIPTION OF CERTAIN EMBODIMENTS OF THE INVENTION

There is described a case, cover or box formed having at least one wall, or at least one part of a wall, formed from a layer of microcellular foam and a layer of self-reinforced polymer woven composite. The layer of microcellular foam is an inner layer of the wall of the case compared to the layer of self-reinforced polymer woven composite. A case, box or cover according to the enclosed description will generally be rigid or semi-rigid and resilient, so that it holds its shape and maintains a given shape of the cavity inside the case, even when no item is contained within the cavity.

Both the microcellular foam and the self-reinforced polymer woven composite are specific forms of material, having particular benefits when forming a case, box or cover. The microcellular foam is a form of polymer foam that, once formed, comprises a large number of tiny (typically 0.1-100 micrometres) bubbles or cells within the structure of the foam. The foam is formed by dissolving gas under high pressure into a polymer, relying on thermodynamic instability to cause a uniform arrangement of the gas bubbles (a process otherwise known as nucleation). Once the polymer material cools or sets, the uniform arrangement of bubbles remain within the foam structure. The specific density of the foam can be varied by use of different gases and gas pressures during manufacture. The material tensile strength decreases with foam density (in other words, the tensile strength decreases as more gas is dissolved into the polymer material during manufacture of the foam). However, the tensile strength-to-weight ratio of the material is high. The size of the bubbles (or cells) within the foam is similar to that of the wavelength of light, and so microcellular foam retains the appearance of a solid material unless under close inspection.

Thus, microcellular foam offers a closed-cell foam with consistent cell formation, and that with appropriate choice of density is a lightweight, but relatively rigid material. It provides particularly good strength-to-weight performance ratio, and high elasticity. A still further benefit is a lack of water absorption, as a result of the closed cell nature of the foam.

Preferable types of microcellular foam to be used within the case or cover described herein include a microcellular polypropylene single polymer composite, a microcellular polyethylene single polymer composite, or a microcellular polyethylene/polypropylene blend. The microcellular polypropylene, being formed without a cross-linked construction, allows for recyclability. For a given volume of microcellular polypropylene, the weight is significantly less (around half) than for the same volume of ethylene-vinyl acetate foam, as less polymer material is used in the microcellular foam. However, the microcellular polypropylene retains high strength, high resilience, and high elasticity.

In view of all these benefits, a microcellular foam is particularly beneficial for use in an inner layer of a wall of a transportable case or cover. With appropriate choice of density, the layer can provide some structure and rigidity to the case or cover, whilst also being a very light weight and strong protective layer that absorbs the energy of impacts.

The outer layer of the described case or cover is formed from a self-reinforced polymer woven composite. This is a specific form of self-reinforced polymer material. Self-reinforced polymers are themselves a special category of polymer materials, in which reinforcing fibres of a polymer are embedded within a matrix of the same polymer. Typical self-reinforced polymer material may be formed as tapes, which can then be layered and compressed together to form a sheet of the material. The tapes may be formed in one of two ways. A first option is by extrusion of strands of polymer, coated in a layer of the same polymer of a different grade, wherein the coated strands are aligned and pressed together under heat and pressure so that the coating layer melts and forms a polymer matrix surrounding the stands to form the tape. A second option is that stretched fibres of a polymer are arranged in alignment, and application of heat and pressure melts the outer surface of each fibre, and forms a polymer matrix surrounding the fibres, thereby creating tapes.

As noted above, sheets or panels of the self-reinforced polymer material may be built up by layering of self-reinforced polymer tapes (in other words, lamination of multiple tapes), followed by compressing the layers of tapes under heat and pressure (i.e. thermo-compression of the laminated tapes). Sheets or panels of self-reinforced polymer formed in this way have many uses, as they provide a highly durable and strong material, which is lightweight. The thickness of such sheets or panels can easily be modified or adapted by layering and compression together of different numbers of layers of tapes of self-reinforced polymer. Nevertheless, there can also be draw backs to using the self-reinforced polymer sheets or panels formed in this way. In particular, delamination can occur as a result of repeated abrasion at the edge of the laminated sheets, and air pockets between layers can sometimes be observed.

A new composition of the self-reinforced polymer material has recently been developed. This is known as self-reinforced polymer woven composite. This makes use of yarns or threads formed of the fibres of the self-reinforced polymer materials as described above. The yarns or threads can be woven into a fabric or textile of the self-reinforced polymer material. For instance, the yarns or threads can be interlaced using a weave in a similar manner to standard textile or fabric formation. The woven yarns or threads can then be heated and compressed, in order to form bonds between the yarns or threads. In some cases, before weaving of said varns or threads, multiple strands of the yarns or threads can be twisted or braided together to form a stronger, thicker yarn or thread (in the manner of forming a rope). The density and thickness of the self-reinforced polymer woven composite can be adapted by changing the thickness of the individual yarns and threads (by increasing the number of braided strands), or by changing the number of interlacing threads within a given unit area (in other words, changing the number of weaves per unit area, or pics per unit area). An example of self-reinforced polymer woven composite material is Dewforge™ by James Dewhurst™, which is a self-reinforced polypropylene woven composite (see http://www.jamesdewhurst.com/2020/11/19/dewforge-james-dewhursts-easy-to-forge-srpp-woven-composite/, accessed 25 Oct. 2021).

The self-reinforced polymer woven composite provides all the benefits of a standard self-reinforced polymer material. In particular, it has a very high strength-to-weight ratio, being very durable but lightweight, even when provided as a thin sheet. It has high resistance to perforations, it does not retain and is not damaged by water (waterproof) and is recyclable. However, the woven material also has an added benefit of avoiding the delamination seen with typical, layered self-reinforced polymer materials sheets, in view of interlaced structure of the polymer threads or yarns. The use of the self-reinforced polymer woven composite material avoids the need to layer and compress the self-reinforced material before forming the case, and so provides a less labour-intensive manufacturing process. The self-reinforced polymer woven composite material is more impact resistant for a given thickness or density, with greater resistance to tearing, meaning thinner and so more lightweight layers can be used. The self-reinforced polymer woven composite material may be woven into three-dimensional shapes before bonding to other layers. Weaving into said shapes (prior to bonding) allows formation of contoured shapes, including cases with deeper cavities, without use of lap cuts or joins.

The particular combination of a self-reinforced polymer woven composite outer layer and a microcellular foam inner layer has been found to have particular advantages for forming cases, boxes or covers. In particular, the combination of materials is beneficial for providing a rigid (or semi-rigid) box having a defined shape (with a cavity within the case that retains its shape even when an item is not within the cavity). Such cases can be formed by layering the self-reinforced polymer woven composite material with the microcellular foam material, and then moulding or forming the shape of a wall of the case within a press (for instance, to form a ‘shell’ being part of the wall of the case). However, surprisingly it has been found that presses suitable for moulding ethylene-vinyl acetate (EVA) foam can be used with the combination of self-reinforced polymer woven composite and microcellular foam, and that these impart enough heat and pressure to mould the self-reinforced polymer woven composite and microcellular foam layers. In comparison, pressing of the layered form of self-reinforced polymer would typically require higher temperatures and pressures, greater than those imparted by a press designed for use with EVA foam. In general, presses suitable for moulding EVA foam will be of lower quality than presses typically used to mould layered (i.e. non-woven) self-reinforced polymer material. Thus the presses used to mould a combination of self-reinforced polymer woven composite and microcellular foam may be lower cost to obtain, customise and then run in order to manufacture the described case, than compared to manufacture of a case formed of other types of self-reinforced polymer.

It will be understood that other methods of moulding or forming the layers of the wall of the case may be used. This includes bladder systems for forming and moulding polymers. Said bladder systems can be used to apply outward pressure on polymer layers, to form a cavity. Vacuum bladder techniques could also be used.

Use of the self-reinforced polymer woven composite allows moulding of the outer surface of the case or cover at lower temperatures and pressures. For instance, the self-reinforced polymer woven composite can be moulded at a preferred temperature range of 140° C. to 160° C. and preferred pressure of 2 to 4 tonnes per square inch (2,812 to 5,624 tonnes per square metre), as compared to a preferred temperature range of 170° C. to 180° C. and preferred pressure range of 20 to 50 tonnes per square inch (28.122 to 70,307 tonnes per square metre) for the typical layered self-reinforced polymer material. Application of these greater temperatures and pressures to a layered structure having a layer of microcellular foam would damage the foam structure of the microcellular foam. In contrast, lower temperatures are required to mould the self-reinforced polymer woven composite. It has been found that the heat penetrates the self-reinforced polymer woven composite more easily than the layered self-reinforced polymer composite, in view of the woven structure of the material. This allows heating at the interface of the self-reinforced polymer woven composite and the microcellular foam to a temperature sufficient for bonding, without significant damage to the foam structure.

Due to the nature of the self-reinforced polymer woven composite, very small holes can remain between woven threads (or pics) of the self-reinforced polymer woven composite. Although with sufficient heat and pressure such holes could be closed (being filled by the polymer matrix surrounding the threads), such heat and pressure would damage the structure of the foam layer when forming the described case. Therefore, small (microscopic) holes may remain in the self-reinforced polymer woven composite used within the presently described case, which in turn can permit small amounts of water to pass through the outer layer. For this reason, the closed cell nature of the microcellular foam is particularly significant, as it causes the microcellular foam not to retain or absorb water. This is opposed to a foam such as expanded polypropylene (ePP), which may not be suitable for use with self-reinforced polymer woven composite as the structure of expanded polypropylene (which is formed by combining many tiny beads of polypropylene material) can absorb or retain some water. Thus, a closed cell foam is ideally used, with the microcellular foam providing the most preferred option in view of its other characteristics.

In view of the above, the specific combination of self-reinforced polymer woven composite and microcellular foam has particular advantages. It can be bonded and moulded at lower temperatures, which do not damage the foam structure of the foam layer (and which is more energy efficient and lower cost for manufacture). The case is made waterproof by the specific combination of the microcellular foam with the self-reinforced polymer woven composite. As such, the self-reinforced polymer woven composite layer can be considered to provide a protective shell structure (or skeleton) for the case or cover, whereas the microcellular foam provides a waterproof layer with elasticity for absorbing impact energy. Accordingly, the a case having a self-reinforced polymer woven composite layer and a microcellular foam layer combine to provide advantages that would not be apparent from the individual characteristics of the material layers considered alone.

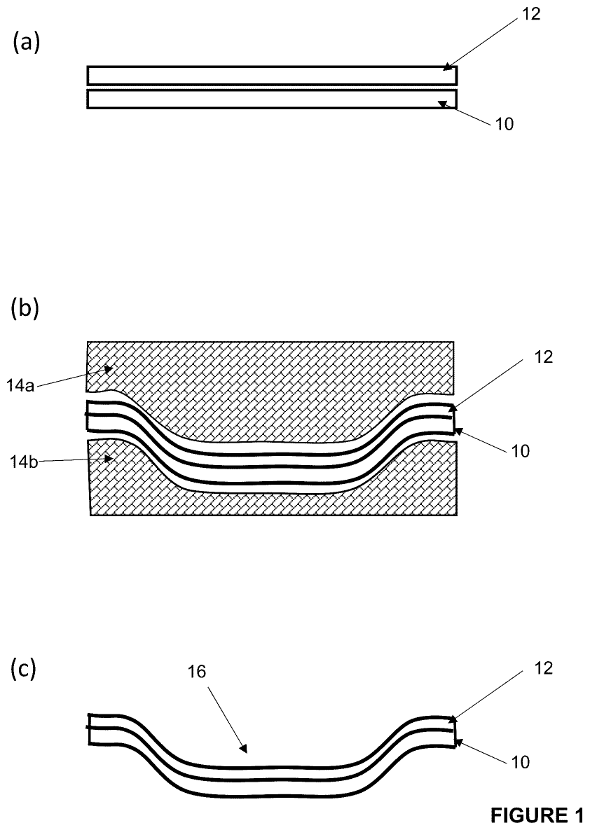

FIG. 1 (a) shows a cross-section of the layers used to form a wall of a case according to an embodiment of the invention. FIG. 1 (a) shows a first layer of microcellular foam 10, which here is microcellular polypropylene single polymer composite. On top of and covering the microcellular foam layer 10 is a layer of self-reinforced polymer woven composite 12. In this example, the self-reinforced polymer woven composite 12 is self-reinforced polypropylene woven composite. Prior to moulding, the layers 10, 12 may be arranged loosely on top of one another.

FIG. 1 (b) shows the layers being compressed in the jaws 14a. 14b of a press. The jaws 14a, 14b of the press are heated, so that the layers 10, 12 are both compacted and heated simultaneously. The jaws 14a. 14b may be heated prior to application, or may be actively heated by embedded heating elements during moulding. The application of heat and pressure causes melting of at least some portion of the polymer in each of the microcellular foam layer 10 and the self-reinforced polymer woven composite layer 12. Flow of the melted (i.e. malleable) materials allows bonds to be formed between the two layers 10, 12, so that they become joined at their interface.

The first 14a and second 14b jaws of the press each have a cooperating contour or shape. Compression of the layers 10, 12 between the jaws 14a, 14b of the press forges or imparts the given contours or shape to the layers 10, 12. When the microcellular foam layer 10 and the self-reinforced polymer woven composite layer 12 are cooled (for instance below their melting points, and/or to room temperature) the layers 10, 12 are set in a shape having the contour imparted by the jaws 14a. 14b of the mould or press (as shown in FIG. 1 (c)). In this way, the layered structure is bonded whilst also being formed into a shape having a cavity 16 suitable to receive at least part of an item to be carried or contained in the eventual case or cover.

In the specific example described with respect to FIG. 1 (b), layers of microcellular polypropylene single polymer composite and self-reinforced polypropylene woven composite are used. The microcellular polypropylene has a density of around 45 grams per litre, and the layer has a thickness of around 6 mm before being placed in the mould. The self-reinforced polypropylene woven composite has a density of around 900 grams per cubic metre, and the layer has a thickness of around 6 mm before being placed in the mould. The layers are then compressed between the jaws of the press at a temperature of around 150° C. and under a pressure of around 2.5 tonne per square inch. The layers are allowed to cool to room temperature within the jaws of the press. It is found that upon cooling, the thickness of the microcellular polypropylene has reduced by around 30%, with an equivalent increase in density. Moreover, the self-reinforced polypropylene woven composite layer of the finished, moulded shape will be around 1 to 1.5 mm.

It should be noted that during the moulding of the layers, care must be taken to impart sufficient heat to the self-reinforced polypropylene woven composite to allow melting of its polymer matrix, which also avoiding application of excess heat and pressure to avoid crushing (or distorting the microcellular structure of) the microcellular foam. It has been found that for this reason the density of the self-reinforced polypropylene woven composite material that can be used within the layered structure should be 1200 grams per cubic metre or less, and ideally 900 grams per cubic metre or less. If denser self-reinforced polypropylene woven composite material is used, insufficient heat transfer through the self-reinforced polypropylene woven composite material is achieved to melt the polymer matrix and create a good bond with the microcellular foam.

The process of heating and compacting in a mould may be used to form appropriately shaped walls of the case. The moulded layered structure may be trimmed, as necessary, and then multiple walls may be joined at their perimeter to form the case. In some circumstances, the join may be a seam formed by thermal or sonic welding. Alternatively, the walls may be connected to a hinge panel (for instance via stitching, sonic welding or thermal welding) to provide a hinge for opening and closing the case and to provide access to the cavity therein. A reversible closure or fastener (such as a zip fastener, or a flap having hoop-and-loop fastener or press studs thereon) may be used to connect adjoining portions of the wall to close the cavity within the case.

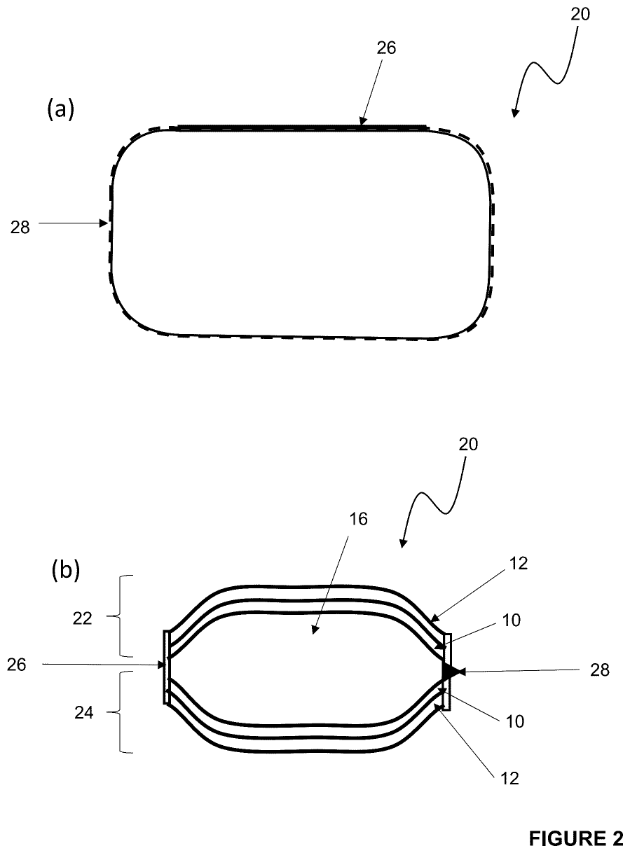

FIG. 2 (a) shows a plan view, and FIG. 2 (b) shows a cress-sectional view, of a case 20 comprising a first 22 and a second 24 wall each formed using the moulded layers of microcellular foam 10 and self-reinforced polymer woven composite 12, as described above. Each wall 22, 24 has a similar concave shape to provide a cavity 16. The two walls 22, 24 are arranged so that the microcellular layers 10 are opposing each other and the cavity 16 is enclosed between the walls. The cavity 16 can contain an item, to be transported in the case.

In the example of FIGS. 2 (a) and 2 (b), the walls are joined at one portion of their perimeter edge by use of a hinge panel 26 to form a hinged connection. The hinge panel 26 may itself be formed of self-reinforced polymer (or self-reinforced polymer woven composite). At the remaining part of their perimeter edges, the wall are reversible joined by use of a zip fastener 28. Said hinged panel and/or fastener can be stitched to the wall portions comprising the self-reinforced polymer woven composite layer 12 and microcellular foam 10. As an alternative, the hinge panel and the fastener could be connected to the wall portions by heat welding or ultrasonic welding. Where stitching is used, a tape may be glued (or a plasticised compound or glue may be spread) over the stitched seam, in order to maintain waterproofing of the case. As will be understood by the person skilled in the art, the hinge may be formed by any other suitable method.

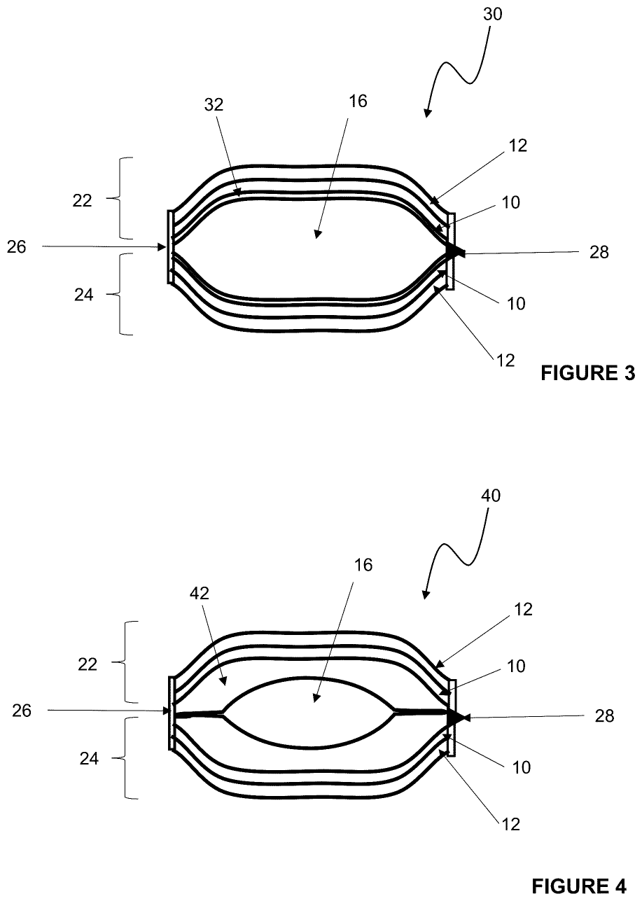

FIG. 3 shows a case 30 having walls similar to those of the case 20 of FIG. 2 (b). However, in this example, an additional lining layer 32 is applied. The lining layer 32 is arranged to line the walls of the cavity 16 within the case, so that the microcellular foam layer 10 is between the lining layer 32 and the self-reinforced polymer woven composite layer 12. Here, the lining layer 32 is a soft nylon layer. However, a felt layer, or a layer of spray on velour or flock could be applied. A thermal insulation layer, or thermally reflective layer could be used as a lining layer 32, especially where items in the box are to be insulated from changes in temperature. The lining layer 32 may be bonded to the microcellular foam 10 across its surface, or may be bonded only at its perimeter.

FIG. 4 shows a case 40 having walls similar to those of the case 20 of FIG. 2 (b). However, in this example, an additional foam layer 42 is applied. The additional foam layer 42 is arranged so that the microcellular foam layer 10 is between the additional foam layer 42 and the self-reinforced polymer woven composite layer 12. The additional foam layer 42 may be bonded to the microcellular foam layer 10, or may be a removable insert. The additional foam layer 42 may be moulded or contoured to receive specific features of an item to be placed inside the cavity 16 of the case. The additional foam insert or layer 42 may be formed of a foam having a lower density (and being less rigid) than the microcellular foam of the microcellular foam layer 10.

It will be understood that still further layers could be added to the described case, including a decorative outer layer, a thermal or waterproof outer layer, or a combination of inner layers (including a plurality of foam layers, in some cases of varying densities), as described above. A metallic and/or reflective layer could be added to prevent scanning of items within the case when the case is closed.

It will be understood that the described case 20, 30, 40 may be suitable for transportation and/or storage of a wide variety of items. The cases 20, 30, 40 are especially useful where a lightweight, protective and semi-rigid cover is required. The cases may be useful to carry general items within logistic or transportation services. The cases may be configured to closely fit specific items, such as items of military equipment, guns, sport or hobby equipment, or scientific instruments. The cases may be configured to carry food items, or other delicate items requiring protection from impact and crushing. The cases may be formed with a thermally insulated lining to provide a temperature controlled cavity for medicines or food items (as an example).

In certain examples of the case, additives can be added to the polymer material of the microcellular foam or the self-reinforced polymer woven composite layer. For instance, an additive to disrupt an infra-red signal could be introduced. This could be especially beneficial where the case is to be used for housing or transporting military equipment (for example but not limited to, guns, drones or surveillance equipment). Such additives can protect objects from detection by various sensors in a wide spectral range, and may include titanium oxide and/or black carbon nanoparticles. Alternatively or additionally, a fire retardant additive can be applied within the polymer material of the microcellular foam or the self-reinforced polymer woven composite layer, to reduce the flammability of the wall(s) of the case or cover. The additives to the self-reinforced polymer woven composite layer may be in the form of strands of fire retardant material or near-infra-red disrupting material woven into the woven composite layer.

### Application of a Lining Layer and or Coating Layer

As discussed above, a lining layer may be applied to cover the internal wall of the cavity. A coating layer may be applied to the outside surfaces of the case. The lining layer and/or coating layer may be a soft-feel or felt layer. In some examples, the lining layer and/or coating layer may be formed from the same type of polymer as the other layers of the walls of the case. Use of the same type of polymer provides a number of benefits. Firstly, use of the same type of polymer allows for bonding of adjacent layers by the application of heat and pressure, and so better adhesion than use of a glue or other adhesive. In particular, better adhesion is provided by intermixing of the same polymer at melted portions of the interfacing surfaces of the lining layer (or coating layer) with another adjacent polymer layer. Once cooled, chemical bonds are formed. Secondly, use of the same type of polymer across all the layers of the case allows for easier end-of-life recycling, as separation of the different layers of the case is not required for recycling.

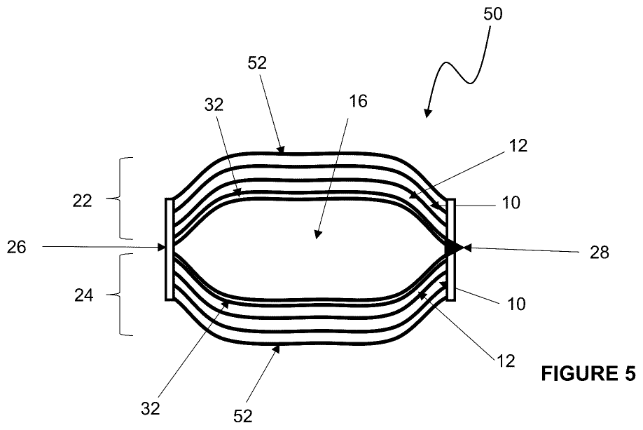

FIG. 5 shows an example of a case 50 having walls similar to those of the case 20 of FIG. 2 (b). However, in this example, the self-reinforced polymer woven composite layer 12 is internal to the microcellular foam layer 10, so that the self-reinforced polymer woven composite layer 12 is closer to the cavity than the microcellular foam layer 10.

In the example of FIG. 5, a lining layer 32 is applied. The lining layer 32 is arranged to line the walls of the cavity 16 within the case, so that the self-reinforced polymer woven composite layer 12 is between the lining layer 32 and the microcellular foam layer 10. Here, the lining layer 32 is a polymer jersey fabric (such as polypropylene jersey fabric), being the same type of polymer as the self-reinforced polymer woven composite layer 12 and the microcellular foam layer 10. The lining layer 32 may be bonded to the self-reinforced polymer woven composite layer 12 across its whole surface, or may be bonded only at its perimeter. Where the lining layer is made of the same type of polymer as the self-reinforced polymer woven composite layer 12 and the microcellular foam layer 10, bonding may be accomplished by applying heat and pressure to the stacked or laminated layers.

In the example of FIG. 5, an additional coating layer 52 is also applied. The additional coating layer 52 may be a polymer brushed tricot layer or polymer jersey fabric layer. Ideally, the additional coating layer 52 will be formed of the same type of polymer as the self-reinforced polymer woven composite layer 12 and the microcellular foam layer 10. The additional coating layer 52 is arranged so that the microcellular foam layer 10 is between the additional coating layer 52 and the self-reinforced polymer woven composite layer 12. The coating layer 52 covers the outermost surface of the case. The additional coating layer 42 may be bonded to the microcellular foam layer 10, for instance by application of heat and/or pressure.

It will be understood that the bonding of the lining layer 32 and/or coating layer 52 by application of heat and/or pressure may take place at the same time as the step of bonding (thermo-bonding) and moulding the self-reinforced polymer woven composite layer 12 and the microcellular foam layer 10, as described above.

In an alternative, rather than the lining layer 32 and/or coating layer 52 being bonded to the self-reinforced polymer woven composite layer 12 and/or the microcellular foam layer 10 by application of heat and pressure, a bridging layer could be used. The bridging layer consists of a polypropylene, polyethylene, or polyethylene terephthalate film. The bridging layer is arranged between the lining layer 32 and/or coating layer 52 and the adjacent self-reinforced polymer woven composite layer 12 and/or the microcellular foam layer 10. The bridging layer has a melting temperature that is lower than the self-reinforced polymer woven composite layer 12 and/or the microcellular foam layer 10. For instance, where a self-reinforced polypropylene woven composite layer and/or the microcellular polypropylene foam is used, the bridging layer would have a melting temperature of around 100° C. to 110° C. which is not sufficient to melt the self-reinforced polypropylene woven composite layer or the microcellular polypropylene foam and only sufficient to melt the bridging layer. Once the melted bridging layer cools, it acts as an adhesive or bonding layer between the adjacent layers. In specific embodiments, the bridging layer could be considered a melt layer or adhesive melt layer. The bridging layer could be used to bond polymer layers as well as nylon or felt layers to the self-reinforced polymer woven composite layer 12 and/or the microcellular foam layer 10.

In certain examples, the lining layer 32 and/or coating layer 52 may be formed of a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer.

As previously described, the lining layer 32 and/or coating layer 52 may be reflective, for instance for use as an insulation layer or heat reflective layer. The reflective layer may be used in temperature controlled boxes, such as those for containing or transporting food or medicines. In a first example, the reflective layer may be a foil made from a polymer, such as polypropylene. The polymer foil can be applied to an adjacent self-reinforced polymer woven composite layer or microcellular polymer foam layer using glue or by application of heat and pressure. In a second example, the reflective layer may be a foil layer “sandwiched” between two layers of polymer (such as polypropylene) and then applied to the adjacent self-reinforced polymer woven composite layer or the microcellular polymer foam layer using glue or by application of heat and pressure. In another specific example, a layer of microcellular foam, a layer of self-reinforced polymer woven composite and a lining layer may be bonded together and moulded into shape simultaneously, by application of heat and pressure (for instance by compaction between the jaws of a mould or press). In one particular example, the self-reinforced polymer woven composite comprises a self-reinforced polypropylene woven composite having a density of 450 g/m³, and the microcellular foam comprises a polypropylene microcellular foam having a density of 45 kg/m³. Here a press for bonding and moulding these layers may be applied for around 1 minute, at around 155° C. and 300 psi. However, the press may be applied for between 30 and 180 seconds, at a temperature of between 140° C. to 170° C. In another particular example, the self-reinforced polymer woven composite comprises a self-reinforced polypropylene woven composite having a density of 900 g/m³, and the microcellular foam comprises a polypropylene microcellular foam having a density of 60 kg/m³. These layers may be bonded and moulded using a longer press and/or a higher temperature press (for example, having a time and/or temperature increased by between 10-30% to bond and mould these higher density layers than compared to the first example).

Although many of the specific examples described above show the layered structure being used in all walls of the case, it will be understood this is not limiting. Instead, the layered structure could be used as only one wall of the case, or only part of one wall (for instance, as a panel within a wall). In the various example configurations of the transportable case discussed above, specific arrangements of combinations of a lining layer, microcellular foam layer, self-reinforced polymer woven composite layer and/or coating layers are shown. However, it will be understood that different combinations of a lining layer, microcellular foam layer, self-reinforced polymer woven composite layer and/or coating layers may be used. For instance, the microcellular foam layer may be an inner layer, being closer to the cavity than the self-reinforced polymer woven composite layer. Alternatively, the self-reinforced polymer woven composite layer may be an inner layer, being closer to the cavity than the microcellular foam layer. A lining layer and/or coating layer may also be applied. In some cases, the walls of the cases may be formed (inside to outside) as a microcellular foam layer, followed by a self-reinforced polymer woven composite layer, followed by a microcellular foam layer. Instead, the walls of the cases may be formed (inside to outside) as a self-reinforced polymer woven composite layer, followed by a microcellular foam layer, followed by self-reinforced polymer woven composite layer. The combination of layers may be chosen based on the requirements of the item to be contained in the case.

The transportable case as described here may be employed for various uses. The cases may be used for transportation or storage or packaging if items. Some specific examples include suitcases, suit or dress bags, watch boxes, sunglasses cases, cases for high value items, perfume boxes, cases for sports equipment, cases for hobby equipment (such as camera equipment), cases for medical equipment (including for transportable storage of an ‘epi pen’), or portable device (laptop or mobile device) cases.

### Formation of a Helmet Using the Layered Structure

A lightweight, relatively thin-skinned and yet very strong helmet can be formed using the layered structure similar to the transportable box. The helmet is to be worn on the head of a user, to protect the head from impacts or applied shearing forces. The helmet could be worn by a human or animal. The helmet may be of the type worn in sports (such as for cycling or water sports).

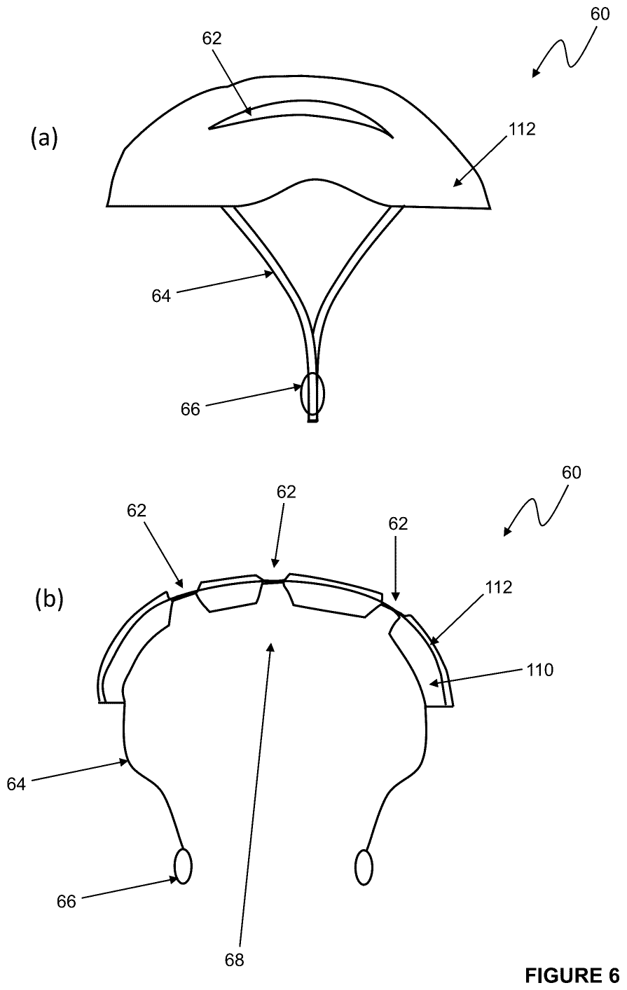

FIG. 6 (a) shows a side view of such a helmet 60, and FIG. 6 (b) shows a cross-section from a front view of the same helmet 60. The helmet is of a typical size and shape, for instance to fit a user's head. However, as can be seen in FIG. 6 (b), the helmet is formed of a layered construction.

The helmet 60 shown in FIG. 6 comprises a first layer 110, formed of microcellular foam. The helmet further comprises a second layer 112, formed of self-reinforced polymer woven composite, covering at least part of the first layer 110. The first layer 110 and the second layer 112 are bonded together and moulded into a shape defining a cavity 68 for receiving at least part of the user's head, the first layer 110 being an inner layer that is closer to the cavity than the second layer 112. The helmet 60 further comprises straps 64 and at least one buckle 66, in order to allow the helmet to be securely fastened to the user's head.

The characteristics of the microcellular foam and the self-reinforced polymer woven composite are the same as those described above with respect to the transportable case. The microcellular foam may be any type of polymer foam, for instance microcellular polypropylene single polymer composite, a microcellular polyethylene single polymer composite, or a microcellular polyethylene/polypropylene blend. The self-reinforced polymer woven composite may be any type of polymer, such as a self-reinforced polypropylene woven composite or a self-reinforced polyethylene woven composite. Ideally, the same type of polymer will be used for the microcellular foam and the self-reinforced polymer woven composite, in order to improve bonding and more straightforward end-of-life recycling.

The helmet of FIG. 6 comprises structural support regions 62. The structural support regions 62 may each be formed by a compacted region of the bonded together and moulded first layer 110 and second layer 112. The structural support regions 62 provide additional stiffness and strength in order to resist forces applied to the helmet, than when compared to the helmet without said structural support regions. The structural support regions 62 may be more rigid than the surrounding portions of the helmet, and provide a framework or skeleton for the helmet. The shape and location of the structural support regions 62 are selected to provide the maximum strength for the helmet in view of the forces that are likely to be applied when a certain type of helmet is in use.

The compacted regions of the structural support regions 62 may be formed during the bonding together and moulded step, by use of a heated press having contours or undulations that create the compacted regions as patterning in the layers. The compacted regions will have been crushed between the jaws of the press, in order to remove much or all of the air from the air pockets of the microcellular foam 110 in those particular regions. The compacted regions subsequently have a greater density of the microcellular foam (and/or the self-reinforced polymer woven composite) after being formed, than compared to the surrounding layered areas of the helmet. The compacted regions have a thickness that is substantially less than the surrounding areas. For instance, the compacted regions may be 30% or less than the thickness of the thickest portion of the layered helmet structure. In one example, these regions may be around 1 to 3 mm thick.

The helmet is advantageous because it provides a lightweight but very strong helmet. The overall thickness of the helmet around the user's head may be lower than some other, known constructions for a helmet. Furthermore, the presently described helmet comprises layers that can be bonded, shaped and moulded as a single step, whereas known helmets typically are formed as a single shell with foam pads later applied to surfaces within the cavity of the shell (using glue, for example) to provide added comfort. Formation of the helmet as described in the present disclosure improves adhesion between the microcellular foam layer and the self-reinforced polymer woven composite layer. Moreover, the foam layer is continuous, which improves comfort.

The bonding between the microcellular foam layer and the self-reinforced polymer woven composite layer is across the whole surface area of the two layers. In the event that shearing forces are applied to the helmet when in use, there is relatively little movement of the microcellular foam and the self-reinforced polymer woven composite layer, for instance than compared to movement between an outer shell and applied foam pads in a typical helmet construction. Therefore, the presently described helmet, as shown in FIG. 6, may provide safety benefits and improved function for the user.

The helmet may further comprise a coating layer on the outer surface of the helmet (wherein the outer layer is typically the self-reinforced polymer woven composite layer). The helmet may further comprise a lining layer or foam layer on the inside of the cavity, closest to the user's head when the helmet is in use. The lining layer or coating layer may be any one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer. The foam layer may be any type of polymer foam, but is preferably a foam of the same type of polymer as the microcellular foam and the self-reinforced polymer woven composite. Decorative patterning or logos may be applied to an outer surface of the helmet.

A number of combinations of the various described embodiments could be envisaged by the skilled person. All of the features disclosed herein may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

1. A transportable case for containing an item, the transportable case having at least a portion of one or more wall comprising:
a first layer, formed of microcellular foam; and
a second layer, formed of self-reinforced polymer woven composite, covering at least part of the first layer;
wherein the first layer and the second layer are bonded together and arranged in the one or more wall so that the first layer is an inner layer that is closer to a cavity defined within the transportable case than the second layer, wherein the cavity is for receiving at least part of the item.

2. The transportable case of claim 1, wherein the microcellular foam is microcellular polypropylene single polymer composite, a microcellular polyethylene single polymer composite, or a microcellular polyethylene/polypropylene blend.

3. The transportable case of claim 1 or claim 2, wherein the self-reinforced polymer woven composite is a self-reinforced polypropylene woven composite or a self-reinforced polyethylene woven composite.

4. The transportable case of any one of claims 1 to 3, further comprising a lining layer, on an inner surface of the first layer, such that the first layer is between the lining layer and the second layer.

5. The transportable case of claim 4, wherein the lining layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer.

6. The transportable case of claim 5, further comprising a coating layer, on an outer surface of the second layer, such that the second layer is between the coating layer and the first layer.

7. The transportable case of claim 6, wherein the coating layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer.

8. The transportable case of any one of claims 1 to 7, further comprising a foam layer, on an inner surface of the first layer, such that the first layer is between the foam layer and the second layer, or on an outer surface of the second layer, such that the second layer is between the foam layer and the first layer.

9. The transportable case of any one of claims 1 to 8, wherein the first layer has a thickness of 1.2 mm to 18 mm.

10. The transportable case of any one of claims 1 to 9, wherein the first layer has a density of 27.5 to 120 kg/m³.

11. The transportable case of any one of claims 1 to 10, wherein the second layer has a thickness of 0.6 to 1.4 mm.

12. The transportable case of any one of claims 1 to 11, wherein the second layer has a density of 400 to 1200 g/m³.

13. A transportable case for containing an item, the transportable case having at least a portion of one or more wall comprising:
a first layer, formed of microcellular foam; and
a second layer, formed of self-reinforced polymer woven composite, covering at least part of the first layer;
wherein the first layer and the second layer are bonded together and arranged in the one or more wall so that the second layer is an inner layer that is closer to a cavity defined within the transportable case than the first layer, wherein the cavity is for receiving at least part of the item.

14. The transportable case of claim 13, wherein the microcellular foam is microcellular polypropylene single polymer composite, a microcellular polyethylene single polymer composite, or a microcellular polyethylene/polypropylene blend.

15. The transportable case of claim 13 or claim 14, wherein the self-reinforced polymer woven composite is a self-reinforced polypropylene woven composite or a self-reinforced polyethylene woven composite.

16. The transportable case of any one of claims 13 to 15, further comprising a lining layer, on an inner surface of the second layer, such that the second layer is between the lining layer and the first layer.

17. The transportable case of claim 16, wherein the lining layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

18. The transportable case of any one of claims 13 to 17, further comprising a coating layer, on an outer surface of the first layer, such that the first layer is between the coating layer and the second layer.

19. The transportable case of claim 18, wherein the coating layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

20. The transportable case of any one of claims 13 to 19, wherein further comprising a foam layer, wherein the foam layer is on an inner surface of the second layer, such that the second layer is between the foam layer and the first layer, or wherein the foam layer is on an outer surface of the first layer, such that the first layer is between the foam layer and the second layer.

21. The transportable case of any one of claims 13 to 20, wherein the first layer has a thickness of 1.2 mm to 18 mm.

22. The transportable case of any one of claims 13 to 21, wherein the first layer has a density of 27.5 to 120 kg/m³.

23. The transportable case of any one of claims 13 to 22, wherein the second layer has a thickness of 0.6 to 1.4 mm.

24. The transportable case of any one of claims 13 to 23, wherein the second layer has a density of 400 to 1200 g/m³.

25. A method for manufacture of a transportable case for receiving an item, comprising:
providing a first layer, formed of microcellular foam; and
providing a second layer, formed of self-reinforced polymer woven composite, covering at least part of the first layer;
forming at least a portion of a wall of the transportable case by bonding together the first layer and the second layer.

26. The method of claim 25, wherein the bonding comprises heating and compacting together the first and the second layer.

27. The method of claim 25 or claim 26, wherein compacting comprises compressing the first and the second layer in a press.

28. The method of any one of claims 25 to 27, wherein the microcellular foam is microcellular polypropylene single polymer composite, a microcellular polyethylene single polymer composite, or a microcellular polyethylene/polypropylene blend

29. The method of any one of claims 25 to 28, wherein the self-reinforced polymer woven composite is a self-reinforced polypropylene woven composite or a self-reinforced polyethylene woven composite.

30. The method of any one of claims 25 to 29, further comprising providing a lining layer, arranged on a surface of the first layer, such that the first layer is between the lining layer and the second layer, or arranged on a surface of the second layer, such that the second layer is between the lining layer and the first layer.

31. The method of claim 30, wherein the lining layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

32. The method of any one of claims 25 to 31, further comprising providing a coating layer, arranged on a surface of the second layer, such that the second layer is between the coating layer and the first layer, or arranged on a surface of the first layer, such that the first layer is between the coating layer and the second layer.

33. The method of claim 32, wherein the coating layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, a polyethylene reflective layer.

34. The method of any one of claims 25 to 33, further comprising providing a foam layer, the foam layer arranged on a surface of the first layer, such that the first layer is between the foam layer and the second layer, or the foam layer arranged on a surface of the second layer, such that the second layer is between the foam layer and the first layer.

35. The method of any one of claims 25 to 34, wherein the first layer provided prior to the forming step has a thickness of 2 and 20 mm.

36. The method of any one of claims 25 to 35, wherein the first layer provided prior to the forming step has a density of 25 to 100 kg/m³.

37. The method of any one of claims 25 to 36, wherein the second layer provided prior to the forming step has a thickness of 5 to 10 mm.

38. The method of any one of claims 25 to 37, wherein the second layer provided prior to the forming step has a density of 400 to 1200 g/m³.

39. The method of any one of claims 25 to 38, wherein heating comprises heating at least a portion of the first and second layer to a temperature of 130 to 170°.

40. The method of any one of claims 25 to 39, wherein compacting together comprises applying a pressure of 0.1 to 10 tonne per square inch to at least a portion of the first and second layer.

41. The method of any one of claims 25 to 40, wherein compacting together comprises applying a pressure of 1 to 10 tonne per square inch to at least a portion of the first and second layer.

42. The method of any one of claims 25 to 41, further comprising applying a pattern or print to the surface of the second layer or surface of the first layer by hydro dipping.

43. A helmet, for protection of a user's head, comprising:
a first layer, formed of microcellular foam; and
a second layer, formed of self-reinforced polymer woven composite, covering at least part of the first layer;
wherein the first layer and the second layer are bonded together and moulded into a shape defining a cavity for receiving at least part of the user's head, the first layer being an inner layer that is closer to the cavity than the second layer.

44. The helmet of claim 43, wherein the microcellular foam is microcellular polypropylene single polymer composite, a microcellular polyethylene single polymer composite, or a microcellular polyethylene/polypropylene blend.

45. The helmet of claim 43 or claim 44, wherein the self-reinforced polymer woven composite is a self-reinforced polypropylene woven composite or a self-reinforced polyethylene woven composite.

46. The helmet of any one of claims 43 to 45, further comprising one or more structural support, each formed by a compacted region of the bonded together and moulded first and second layer.

47. The helmet of claim 46, wherein each compacted region has a thickness being 30% or less of the thickest region of the bonded together and moulded first and second layer.

48. The helmet of claim 46 or claim 47, wherein each compacted region has a thickness of 1 mm to 3 mm.

49. The helmet of any one of claims 43 to 48, further comprising a lining layer, on an inner surface of the first layer, such that the first layer is between the lining layer and the second layer.

50. The helmet of claim 49, wherein the lining layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer.

51. The helmet of any one of claims 43 to 50, further comprising a coating layer, on an outer surface of the second layer, such that the second layer is between the coating layer and the first layer.

52. The helmet of claim 51, wherein the coating layer comprises one of: a non-woven polymer (or polyolefin) fabric, a punch needle non-woven polymer (or polyolefin) fabric, a polypropylene felt, a brushed polypropylene fabric, a polypropylene brushed tricot, a polypropylene jersey fabric, a polypropylene warp knit fabric, a polypropylene reflective layer, a polyethylene felt, a brushed polyethylene fabric, a polyethylene brushed tricot, a polyethylene jersey fabric, a polyethylene warp knit fabric, or a polyethylene reflective layer.

53. The helmet of any one of claims 43 to 52, further comprising a foam layer, on an inner surface of the first layer, such that the first layer is between the foam layer and the second layer, or on an outer surface of the second layer, such that the second layer is between the foam layer and the first layer.

54. The helmet of any one of claims 43 to 53, wherein the first layer has a thickness of 3 mm to 25 mm.

55. The helmet of any one of claims 43 to 54, wherein the first layer has a density of 25 to 80 kg/m³.

56. The helmet of any one of claims 43 to 55, wherein the second layer has a thickness of 1.5 mm to 15 mm.

57. The helmet of any one of claims 43 to 56, wherein the second layer has a density of 400 to 1200 g/m³.
